(19) United States
(12) Patent Application Publication
(10) Pub. No.: US 2025/0380672 A1
(43) Pub. Date: Dec. 18, 2025

(54) PET LEASH APPARATUS FOR ENTANGLEMENT AVOIDANCE

(71) Applicant: JAMES A. HOWARD, BIRMINGHAM, AL (US)

(72) Inventor: JAMES A. HOWARD, BIRMINGHAM, AL (US)

(21) Appl. No.: 19/240,383

(22) Filed: Jun. 17, 2025

Related U.S. Application Data
(60) Provisional application No. 63/661,507, filed on Jun. 18, 2024.

(51) Int. Cl. A01K 27/00

(52) U.S. Cl. CPC A01K 27/003

(57) ABSTRACT

A pet leash apparatus that includes a lead comprised of a flexible material and a lead attachment in mechanical cooperation with the lead. An elongate member cooperates with a pet collar attachable to a pet and cooperates with the lead attachment. The elongate member is positionable between an extended position by slacking of the lead and a tensioned position by tensioning of the lead. The lead may define one continuous loop, and the lead cooperates with the lead attachment to reposition a gripped portion of the lead proximate a distal end to the proximal end by tensioning of the lead at the gripped portion. A plurality of fasteners is disposed along the lead to alter the lead between a fastened configuration having a plurality of gaps disposed along the lead with one or more of the plurality of fasteners attached to one another and a looped configuration having the one continuous loop with all of the fasteners detached from one another.

### CROSS-REFERENCE TO RELATED APPLICATIONS

The present patent application claims priority and benefit of U.S. Provisional Patent Application No. 63/661,507 filed 18 Jun. 2024 which is hereby incorporated by reference in its entirety herein. The present patent application hereby incorporates by reference in the entirety herein co-pending U.S. patent application ______, filed 17 Jun. 2025 and entitled PET LEASH APPARATUS CONFIGURED FOR DETANGLING OF ENTANGLEMENTS with James A. Howard as inventor.

### BACKGROUND OF THE INVENTION

### Field of the Invention

The present invention relates to pet leashes and more particularly to pet leashes configured to avoid entanglement or allow for detangling entanglements if such should occur.

### Background

A typical leash device as may be used to restrain various pets such as dogs may have various shortcomings. For example, a lead of the typical leash device may become entangled with an obstacle such as a tree and other foliage, a post, furniture, the pet itself, or even the user. In order to extricate the lead and the pet from entanglement with the obstacle, the user may need to retract the lead as the user untangles the lead from the obstacle. Alternatively, the user may pass a lead portion of the lead about the obstacle while gripping the lead with alternating hands in order to untangle the lead from the obstacle thereby continually changing the length of the lead between the hand and the pet. Neither retracting the lead nor altering the locations at which the lead is being gripped is satisfactory. In both of these instances, the length of the lead portion between the location at which the lead portion is being gripped and the pet changes. Such length changes and regripping may disturb the pet, allow the pet to escape, place the user in an awkward position, or have other undesired consequences. Accordingly, there is a need for an improved pet leash apparatus and related methods of use.

### BRIEF SUMMARY OF THE INVENTION

These and other needs and disadvantages may be overcome by the apparatus and related methods of use disclosed herein. Additional improvements and advantages may be recognized by those of ordinary skill in the art upon study of the present disclosure.

A pet leash apparatus disclosed herein includes a lead comprised of a flexible material to resist only tension forces and a lead attachment in mechanical cooperation with the lead, in various aspects. The pet leash apparatus includes an elongate member having a first end that cooperates with a pet collar attachable to a pet and having a second end that cooperates with the lead attachment. The elongate member is positionable between an extended position by slacking of the lead and a tensioned position by tensioning of the lead.

In various aspects, the lead defines one continuous loop, and the lead cooperates with the lead attachment to reposition a gripped portion of the lead proximate a distal end to the proximal end by tensioning of the lead at the gripped portion.

In various aspects, a plurality of fasteners is disposed along the lead to alter the lead between a fastened configuration having a plurality of gaps disposed along the lead with one or more of the plurality of fasteners attached to one another and a looped configuration having the one continuous loop with all of the fasteners detached from one another.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1A illustrates by perspective view an exemplary pet leash apparatus including a lead in a looped configuration according to aspects of the present inventions;

FIG. 1B illustrates by perspective view the exemplary pet leash apparatus of FIG. 1A according to aspects of the present inventions including a lead in a fastened configuration;

FIG. 2A illustrates by perspective view an exemplary implementation of portions of the pet leash apparatus of FIG. 1A;

FIG. 2B illustrates by perspective view another exemplary implementation of portions of the pet leash apparatus of FIG. 1A;

FIG. 3A illustrates by elevation view portions of the exemplary implementation of the pet leash apparatus of FIG. 1A including a lead in a looped configuration;

FIG. 3B illustrates by elevation view portions of the exemplary implementation of the pet leash apparatus of FIG. 1A including the lead in a fastened configuration;

FIG. 3C illustrates by elevation view portions of the exemplary implementation of the pet leash apparatus of FIG. 1A including the lead in another looped configuration;

FIG. 4A illustrates by perspective view another exemplary pet leash apparatus including an elongate member in an extended position and a lead in a looped configuration according to aspects of the present inventions;

FIG. 4B illustrates by perspective view the exemplary pet leash apparatus of FIG. 4A according to aspects of the present inventions including the elongate member in a tensioned position and the lead in a fastened configuration;

FIG. 4C illustrates by perspective view the exemplary pet leash apparatus of FIG. 4A according to aspects of the present inventions including the elongate member in the extended position and the lead in a fastened configuration;

FIG. 5A illustrates by perspective view portions of the exemplary implementation of the pet leash apparatus of FIG. 4A;

FIG. 5B illustrates by perspective view portions of the exemplary implementation of the pet leash apparatus of FIG. 4A;

FIG. 5C illustrates by perspective view portions of the exemplary implementation of the pet leash apparatus of FIG. 4A;

FIG. 6 illustrates by perspective view a third exemplary pet leash apparatus according to aspects of the present inventions;

FIG. 7 illustrates by perspective view a fourth exemplary pet leash apparatus according to aspects of the present inventions;

FIG. 8A illustrates by perspective view the exemplary implementation of the pet leash apparatus of FIG. 1A including the lead entangled with an obstacle; and,

FIG. 8B illustrates by perspective view the exemplary implementation of the pet leash apparatus of FIG. 1A including the lead (which was entangled with the obstacle per FIG. 8A) detangled from the obstacle.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

The pet leash apparatus disclosed herein includes a lead that cooperates with a lead attachment that, in turn, cooperates with a pet collar attachable to a pet. In a looped configuration, the lead may be configured to form a loop grippable by the user, in various aspects. Accordingly, in such aspects, the lead is shaped circularly or curved over on itself to form the loop that is closed and continuous. Fasteners are disposed about the lead so that the lead may be altered between the looped configuration wherein the lead forms the loop moveably engaged with the lead attachment and a fastened configuration absent the loop and in generally fixed engagement with the lead attachment by detachment of the fasteners from one another or attachment of the fasteners to one another, respectively, in various aspects. With the lead in the looped configuration, gripping the lead at a gripped portion anywhere along the loop and then tensioning the lead causes the lead to reposition with respect to the lead attachment until the gripped portion of the lead becomes a most proximal portion of the lead with respect to the lead attachment. Accordingly, the gripped portion of the lead in the looped configuration moves by tensioning of the lead so that any portion of the lead being gripped assumes the same length, e.g., the length between a proximal end of the lead and the lead attachment. With the lead in the fastened configuration, repositioning of the gripped portion of the lead is limited by fasteners attached to one another that block passage of the lead through the lead attachment by contact of the attached fasteners with the lead attachment. The fastened configuration may make the lead more compact eliminating the loop and thus avoiding entanglement of the lead.

In various aspects, the pet leash apparatus includes an elongate member of rigid construction and having a first end and a second end. The first end of the elongate member cooperates with a connector that cooperates with the pet collar, and the second end of the elongate member cooperates with the lead attachment that, in turn, cooperates with the lead, in various aspects. The elongate member springingly positions between an extended position and a tensioned position as the lead is slacked or tensioned, respectively, in various aspects. In the extended position, the elongate member holds the lead away from the pet to avoid entanglement of the lead with the pet, in various aspects.

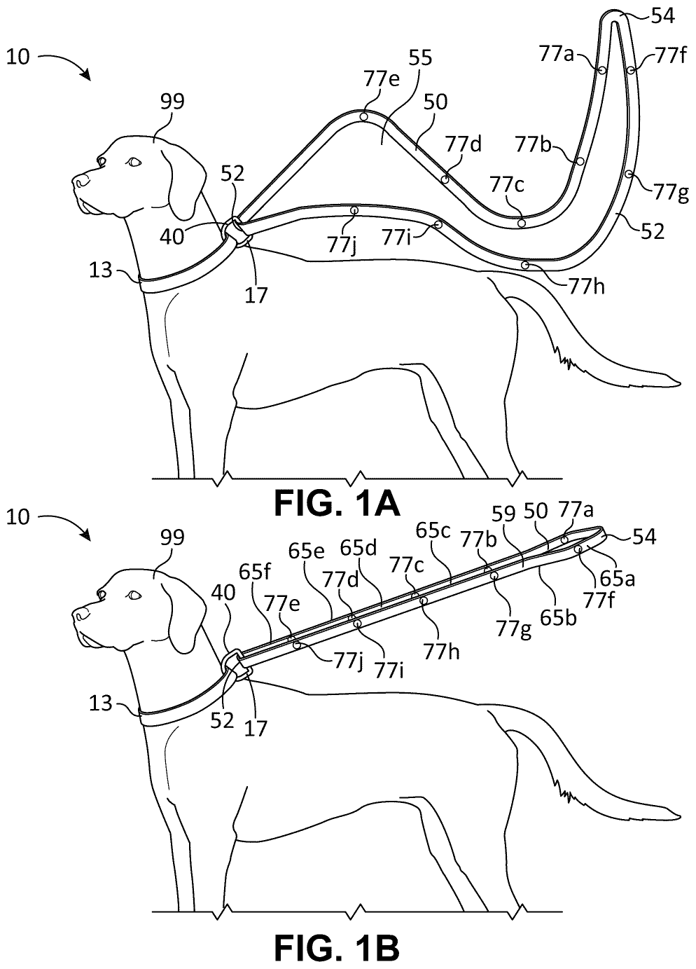

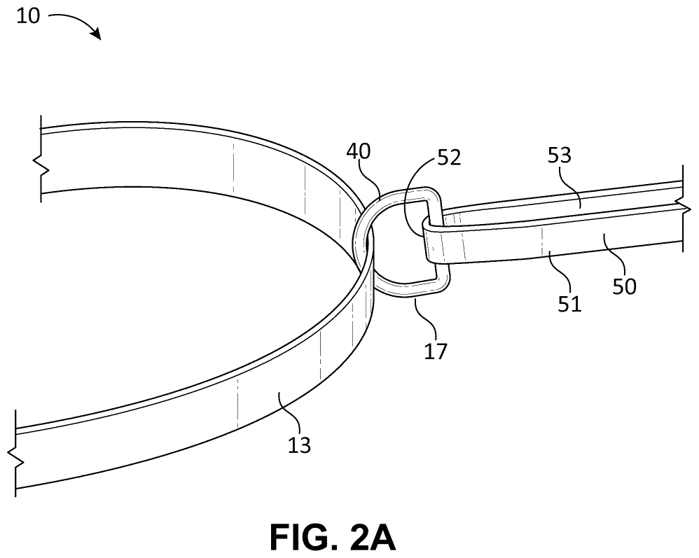

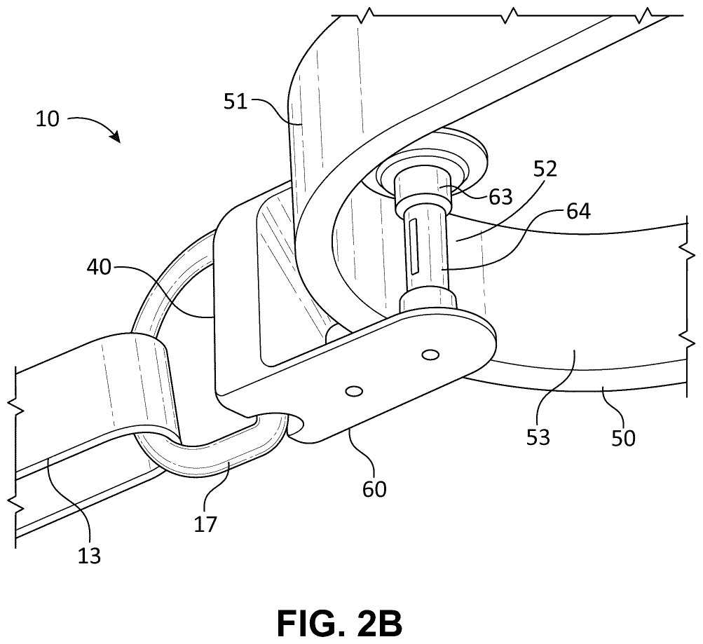

FIGS. 1A, 1B illustrate exemplary pet leash apparatus 10. As illustrated in FIG. 1A, pet leash apparatus 10 includes lead 50 that defines loop 55 in looped configuration 57. As illustrated, lead 50 has distal end 52 and proximal end 54 with distal end 52 being portions of lead 50 proximate lead attachment 40 and proximal end 54 being portions of lead 50 furthest from lead attachment 40. Lead 50 cooperates with lead attachment 40 that engages distal end 52 of lead 50. Lead attachment 40 is configured to allow movement of lead 50 in looped configuration 57 with respect to lead attachment 40 such that any portion of lead 50 around loop 55 may be selectively engaged with lead attachment 40 and any portion of lead 50 may be moved to become proximal end 54. Lead attachment 40 is formed as ring 17 that is connected to pet collar 13, as illustrated in FIGS. 1A, 1B, 2A. Lead attachment 40 may further include various ring(s), clip(s), links, and so forth, as would be readily recognized by those of ordinary skill in the art upon study of this disclosure. Ring 17 may have various shapes including a D-ring, as illustrated, as well as, for example, circular and rectangular shapes.

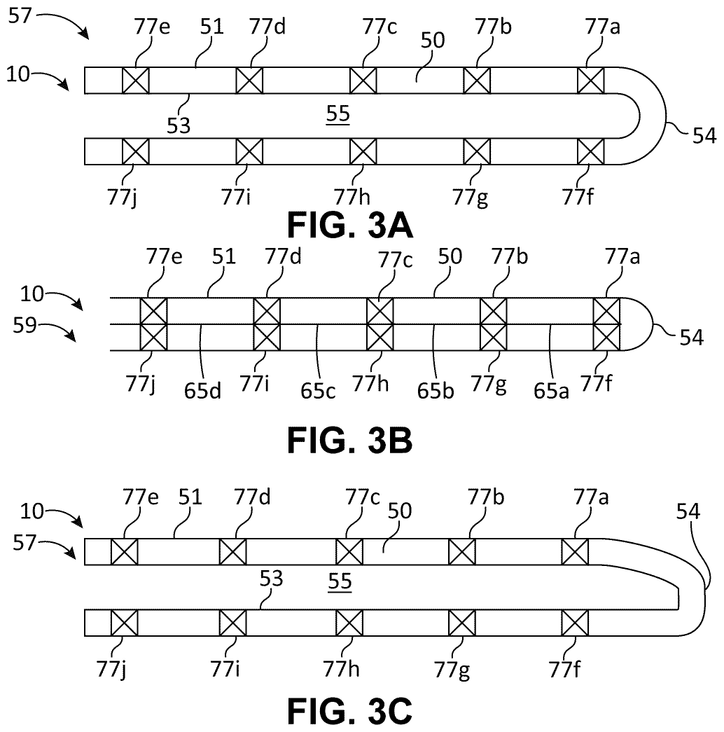

Fasteners 77a, 77b, 77c, 77d, 77e, 77f, 77g, 77h, 77i, 77j disposed along lead 50 cooperate attachably and detachably with one another to alter lead 50 between looped configuration 57 having all of fasteners 77a, 77b, 77c, 77d, 77e, 77f, 77g, 77h, 77i, 77j detached from one another wherein lead 50 forms loop 55, as illustrated in FIG. 1A (also see FIGS. 3A, 3C), and fastened configuration 59 having one or more of fasteners 77a, 77b, 77c, 77d, 77e, 77f, 77g, 77h, 77i, 77j attached to one another, as illustrated in FIG. 1B (also see FIG. 3B). As illustrated for explanatory purposes, fasteners 77a, 77b, 77c, 77d, 77e are attached to fasteners 77f, 77g, 77h, 77i, 77j, respectively, in fastened configuration 59. It should be recognized that at least some, but not all, of fasteners 77a, 77b, 77c, 77d, 77e, 77f, 77g, 77h, 77i, 77j may be attached to one another, in other implementations of fastened configuration 59. While exemplary pet leash apparatus 10 includes ten fasteners 77a, 77b, 77c, 77d, 77e, 77f, 77g, 77h, 77i, 77j for explanatory purposes, it should be understood that other implementations may include various numbers and dispositions of fasteners. As illustrated in FIG. 1A, lead 50 is slacked with loop 55 of lead 50 in looped configuration 57.

Lead 50 is tensioned with loop 55 of lead 50 in fastened configuration 59, as illustrated in FIG. 1B. Lead 50 may be in either looped configuration 57 or fastened configuration 59 whether tensioned or slack, although tensioning of lead 50 may draw fasteners 77a, 77b, 77c, 77d, 77e, 77f, 77g, 77h, 77i, 77j into attachment with one another thereby altering lead 50 from looped configuration 57 into fastened configuration 59. Lead 50 defines gaps 65a, 65b, 65c, 65d, 65e, 65f between fasteners 77a, 77b, 77c, 77d, 77e attached to fasteners 77f, 77g, 77h, 77i, 77j, respectively in fastened configuration 59, as illustrated in FIG. 1B.

Pet collar 13, for example, may be a circular collar that engages a neck of pet 99, as illustrated, may be a harness that engages the neck and body of pet 99, or may be a jacket fitted to pet 99, in various implementations. Thus, pet collar 13 may include additional straps (not shown) and/or other connections that engage the chest, forelegs, etc. of pet 99. While exemplary pet leash apparatus 10 is illustrated as being utilized with a dog, it should be recognized that pet, as used herein, may include various other creatures.

Lead 50, which is flexible to resist tension but not compression, may be comprised, for example, of leather, polyamid (e.g., Nylon), cotton, or other strip of pliant material, and lead 50 may have sufficient length and strength to allow the user to engage with pet 99 such as by walking with pet 99. While lead 50 is illustrated as having a rectangular cross-section, the lead may have other cross-sectional geometries, in other implementations.

FIG. 2B illustrates lead attachment 40 includes pulley 60 attached to ring 17. Ring 17 is then connected to pet collar 13, as illustrated. Lead 50 is engaged with wheel 63 of pulley 60 to allow movement of lead 50 with respect to lead attachment 40 such that any portion of loop 55 may be selectively engaged with lead attachment 40 when lead 50 is in looped configuration 57. Note that, as illustrated, wheel 63 is configured with groove 64 sized to accommodate fasteners, such as fasteners 77a, 77b, 77c, 77d, 77e, 77f, 77g, 77h, 77i, 77j, as lead 50 cooperates with wheel 63 in implementations having fasteners that extend, at least in part, generally outward from lead surface 53 of lead 50.

FIG. 3A illustrates lead 50 in looped configuration 57 with all of the fasteners 77a, 77b, 77c, 77d, 77e, 77f, 77g, 77h, 77i, 77j disposed along lead 50 detached from one another. As illustrated in FIG. 3A, fasteners 77a, 77b, 77c, 77d, 77e are disposed opposite fasteners 77f, 77g, 77h, 77i, 77j, respectively, for attachment to one another.

FIG. 3B illustrates lead 50 in fastened configuration 59 with fasteners 77a, 77b, 77c, 77d, 77e attached to fasteners 77f, 77g, 77h, 77i, 77j, respectively.

FIG. 3C illustrates lead 50 in looped configuration 57 with fasteners 77a, 77b, 77c, 77d, 77e detached from fasteners 77f, 77g, 77h, 77i, 77j, respectively. Fasteners 77a, 77b, 77c, 77d, 77e are illustrated as offset from fasteners 77f, 77g, 77h, 77i, 77j, respectively, to avoid attachment therebetween, in FIG. 3C.

Note that fasteners 77a, 77b, 77c, 77d, 77e, 77f, 77g, 77h, 77i, 77j are illustrated schematically, for example, in FIGS. 3A, 3B, 3C. In various implementations, fasteners, such as fasteners 77a, 77b, 77c, 77d, 77e, 77f, 77g, 77h, 77i, 77j, may be configured, for example, as hook and loop fasteners disposed about lead 50 to cooperate attachably and detachably with one another, mechanical fasteners such as snap button fasteners disposed about lead 50 to cooperate attachably and detachably with one another, magnets disposed about lead 50 to cooperate attachably and detachably with one another, or magnets and ferromagnetic materials disposed about lead 50 to cooperate attachably and detachably with one another. In various implementations, fasteners, such as fasteners 77a, 77b, 77c, 77d, 77e, 77f, 77g, 77h, 77i, 77j, may be disposed entirely internally within lead 50 (e.g., magnets), may be disposed, at least in part, generally coterminous (e.g., hook and loop fastener) with lead surface 51, lead surface 53, or both lead surface 51, 53 of lead 50, or may extend (eg., mechanical fasteners such as snap button fasteners), at least in part, generally outward from lead surface 51, lead surface 53, or both lead surface 51, 53 of lead 50.

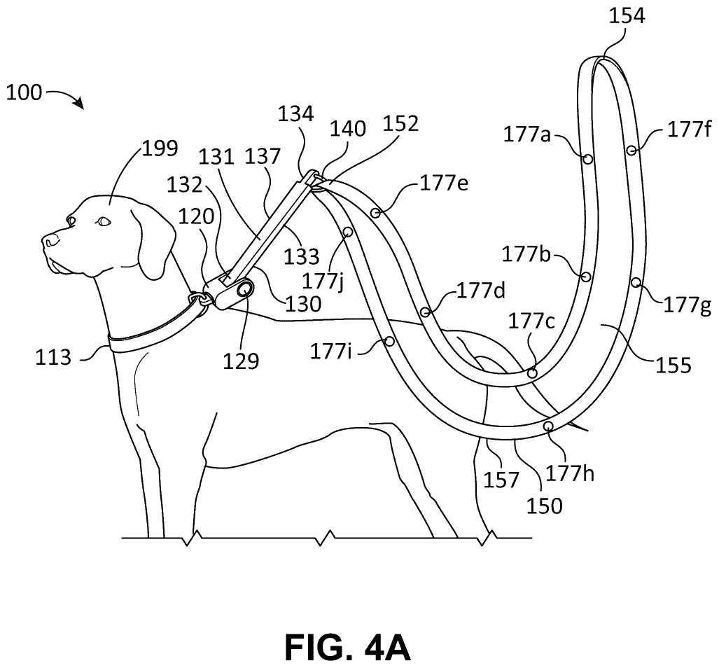

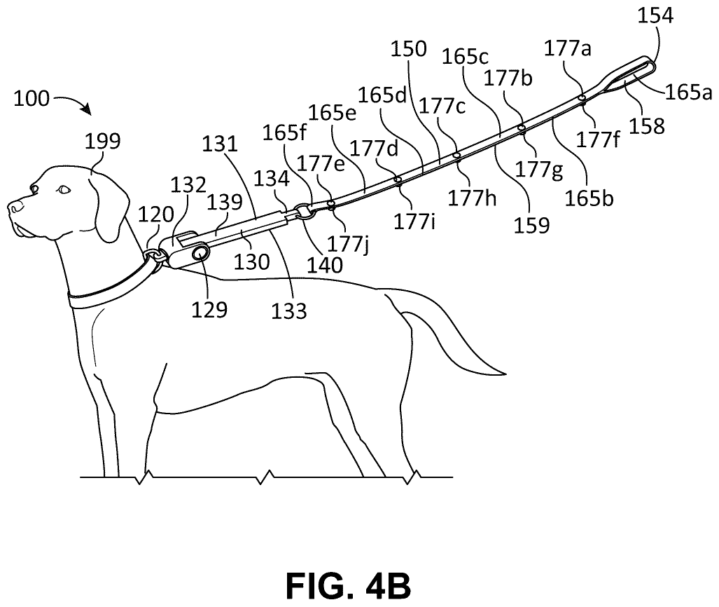

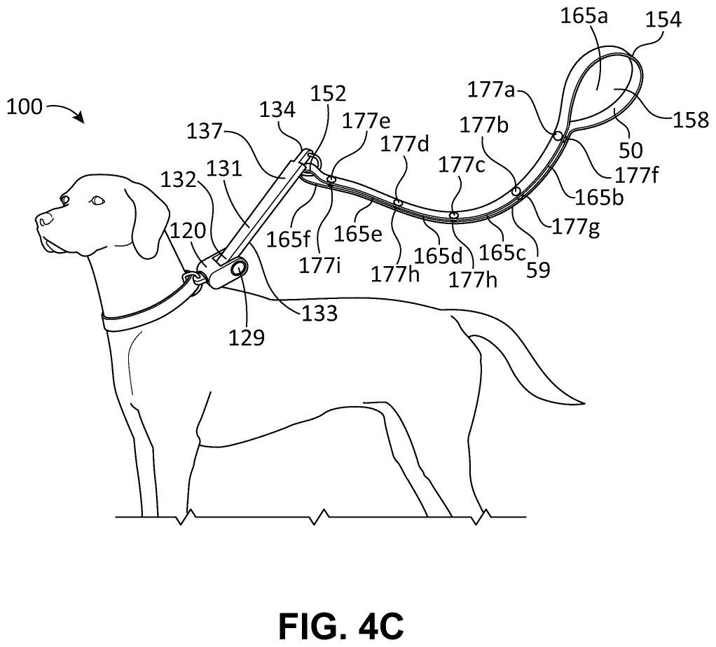

FIGS. 4A, 4B, 4C illustrate exemplary pet leash apparatus 100 that further includes elongate member 130. As illustrated, pet leash apparatus 100 includes lead 150 that defines loop 155. Lead 150 cooperates with lead attachment 140 that engages distal end 152 of lead 150 with lead attachment 140. With lead in looped configuration 157, lead attachment 140 is configured to allow movement of lead 150 with respect to lead attachment 140 such that any portion of loop 155 may be selectively engaged with lead attachment 140. Lead attachment 140 is disposed at second end 134 of elongate member 130, first end 132 of elongate member 130 is attached to connector 120, and connector 120 is connected to pet collar 113, as illustrated. For example, lead attachment 140 may be configured similarly to lead attachment 40 of exemplary pet leash apparatus 10. Second end 134 of elongate member 130 may be configured to form lead attachment 140, in some implementations, or lead attachment 140 such as a ring may cooperate with second end 134 of elongate member 130, in other implementations.

Fasteners 177a, 177b, 177c, 177d, 177e, 177f, 177g, 177h, 177i, 177j are disposed along lead 150 and cooperate with one another to allow alteration of loop 155 between fastened configuration 159 illustrated in FIGS. 4B, 4C and looped configuration 157 illustrated in FIG. 4A by attachment of at least some of fasteners 177a, 177b, 177c, 177d, 177e, 177f, 177g, 177h, 177i, 177j with one another and detachment of all of fasteners 177a, 177b, 177c, 177d, 177e, 177f, 177g, 177h, 177i, 177j from one another, respectively. Again, fasteners 177a, 177b, 177c, 177d, 177e, 177f, 177g, 177h, 177i, 177j are exemplary and various other implementations may include various numbers of such fasteners in various dispositions around lead 150.

Elongate member 130 is positionable between extended position 137, as illustrated in FIGS. 4A, 4C, and tensioned position 139 as illustrated in FIG. 4B. As illustrated in FIG. 4A, lead 150 is slack with lead 150 in looped configuration 157 thereby defining loop 155. For example, in FIG. 4A, pet 199 may be generally standing still, sitting, supine, or otherwise generally at rest so that there is no tension in lead 150 (e.g., lead 150 is slack). Elongate member 130 is in extended position 137 to position lead 150 away from pet 199 thereby avoiding entanglement of lead 150, for example, with the legs or feet of pet 199, in FIGS. 4A, 4C.

As illustrated in FIG. 4B, lead 150 is tensioned with loop 155 of lead 150 in fastened configuration 159 having at least some of fasteners 177a, 177b, 177c, 177d, 177e, 177f, 177g, 177h, 177i, 177j attached with one another so that lead 150 does not form loop 155. Lead 150 defines gaps 165a, 165b, 165c, 165d, 165e, 165f between fasteners 177a, 177b, 177c, 177d, 177e attached to fasteners 177f, 177g, 177h, 177i, 177j, respectively in fastened configuration 159, as illustrated in FIG. 1B. Gap 165a forms handhold 158 in lead 150 at proximal end 154 for the user to grip, as illustrated in FIGS. 4B, 4C. Gaps 165b, 165c, 165d, 165e, 165f may also function as handholds, such as handhold 158. Lead 150, as illustrated, only carries tension force transmitted lengthwise along lead 150 (no compressive force is carried by lead 150 because lead 150 is flexible). When lead 150 is tensioned, elongate member 130 in tensioned position 139 is generally in alignment with lead 150, as illustrated in FIG. 4B, so that elongate member may transmit only tension force between pet collar 113 and lead 150 plus whatever force may be required to maintain elongate member 130 in tensioned position 139.

As illustrated in FIG. 4C, lead 150 is slacked with lead 150 in fastened configuration 159. Elongate member 130 is in extended position 137 to position lead 150 away from pet 199 as lead 150 is slack in FIG. 4C. Elongate member 130 is generally rigid and having sufficient length in extended position 137, for example, to position lead 150 away from legs or feet of pet 199 thereby avoiding entanglement of lead 150 with the legs or feet. Elongate member 130 may be made of hard plastic such as PVC, HDPE, hard rubber, or metal such as aluminum.

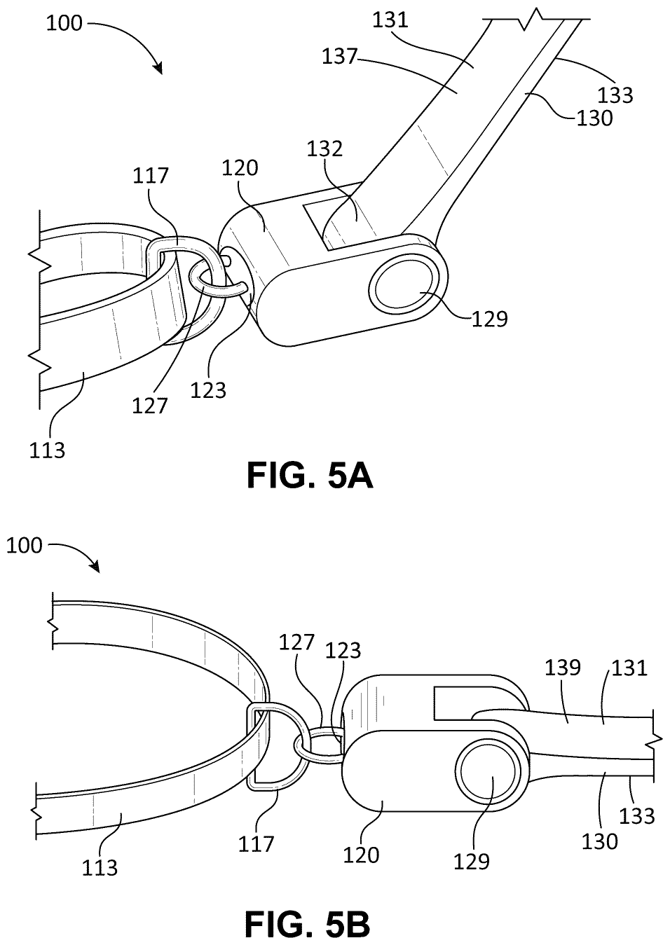

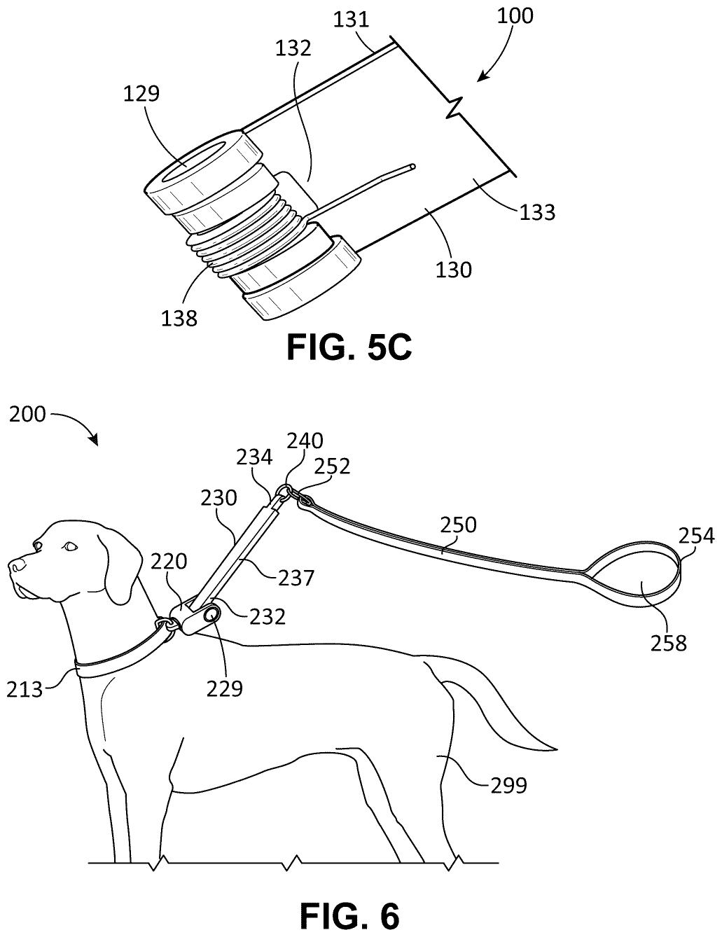

As illustrated in FIGS. 5A, 5B, 5C connector 120 includes hinge 129 and swivel 123. Swivel 123 includes connector ring 127 that connects connector 120 to pet collar 113 by ring 117, as illustrated. While, for explanatory purposes, ring 117 is illustrated as a D-ring that may allow a certain amount of movement between connector 120 and pet collar 113, ring 117 may include a fixed connection such as a riveted loop or other fastener that maintains connector 120 fixed with respect to pet collar 133 and, thus, pet 199. Elongate member 130 cooperates with connector 120 by hinge 129 that allows positioning of elongate member 130 between extended position 137 and tensioned position 139 as slack or tension, respectively, are applied to lead 150. Swivel 123 allows connector 120 and, thus, elongate member 130 to pivot with respect to pet collar 113. By being able to pivot about swivel 123, elongate member 130 in extended position 137 (or in tensioned position 139) may assume a variety of orientations, for example, between extending vertically above and extending outward laterally with respect to pet 199. Connector 120 is illustrated in FIG. 5A as positioning elongate member 130 in extended position 137 generally in a vertical plane in FIG. 5A, and connector 120 is illustrated in FIG. 5B as positioning elongate member 130 in tensioned position 139.

Because elongate member 130 is pivotable, elongate member 130 in tensioned position 139 may be generally in alignment with tensioned lead 150 to transmit only tension force between pet collar 113 and lead 150. That is, with lead 150 tensioned and elongate member 130 in tensioned position 139, there is only tension stress in a longitudinal direction between the first end 132 and second end 134 of elongate member 130. There is no stress perpendicular to the longitudinal direction nor is there any moment at end 132 (because of hinge 129 and swivel 123) that may be transmitted via connector 120 to pet collar 113 and thence to pet 199 other than whatever force against spring 138 is required to maintain elongate member 130 in tensioned position 139. Thus, elongate member 130 need only generally resist tension stress in the longitudinal direction between the first end 132 and second end 134. In certain other implementations, connector may include hinge 129 with swivel 123 being omitted. As illustrated in FIG. 5C, spring 138 cooperates with hinge 129 and with elongate member 130 to position elongate member 130 in extended position 137 when lead 150 is slack. Tensioning lead 150 overcomes spring 138 to position elongate member 130 in tensioned position 139, in this implementation. Elongate member 130 may be configured in other ways to be springingly held in extended position 137 when lead 150 is slack, in other implementations.

FIG. 6 illustrates exemplary pet leash apparatus 200 that includes connector 220 secured to pet collar 213 of pet 299. First end 232 of elongate member 230, which is illustrated in extended position 237 as lead 250 is slack, cooperates with connector 220 by hinge 229, and lead 250 cooperates with lead attachment 240 disposed at second end 234 of elongate member. Lead 250 is formed as an elongate unitary strip of pliant material with distal end 252 fixed to lead attachment 240 and proximal end 254 that includes fixed handhold 258, as illustrated. Accordingly, lead 250 does not transition between a looped configuration, such as looped configuration 57, 157, and a fastened configuration, such as fastened configuration 59, 159, in this implementation. Distal end 252, proximal end 254 including handhold 258, and lead portions intermediate of distal end 252 and proximal end 254 remain in fixed relation with lead attachment 240 and with elongate member 230, in this implementation, in contrast to lead 50, 150 in looped configuration 57, 157. In this implementations, elongate member 230 is positionable between extended position 237 as illustrated in FIG. 6 and a tensioned position, such as tensioned position 139.

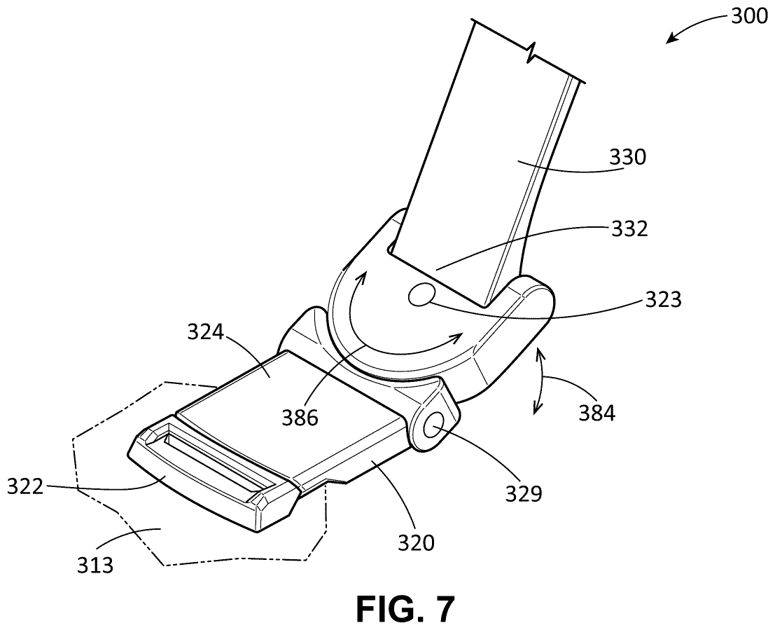

FIG. 7 illustrates exemplary pet leash apparatus 300 that includes connector 320 that cooperates with elongate member 330. In this implementation, connector 320 comprises first connector portion 322 that is fixedly secured to pet collar 313 and second connector portion 324 that releaseably mechanically magnetically engages first connector portion 322. By being in fixed engagement with pet collar 313, first connector portion 322 maintains connector 320 generally in fixed position along the spine about the neck or back of the pet. Pet collar 313 may be configured as a harness or jacket to maintain fixedness of connector 320, in this implementation. Manipulation of connector 320 allows for second connector portion 324 to be removed from first connector portion 322 or for second connector portion 324 to be attached to first connector portion 322, in this implementation. For example, first connector portion 322 and second connector portion 324 of connector 320 may be configured as a FIDLOCK mechanical magnetic device as provided by FIDLOCK GmbH of Hanover, Germany. As illustrated in FIG. 7, first end 332 of elongate member 330 hingedly cooperates with second connector portion 324 of connector 320 by hinge 329, which may be spring loaded, to allow positioning of elongate member 330 in a vertical plane (e.g., up and down) as indicated by arrow 384. First end 332 of elongate member 330 swivelably cooperates with second connector portion 324 of connector 320 by swivel 323, which may be spring loaded, to allow positioning of elongate member 330 in a horizontal plane (e.g., side to side) as indicated by arrow 386, as illustrated in FIG. 7. Spring loading of swivel 323 may preferentially align elongate member with the spine of the pet.

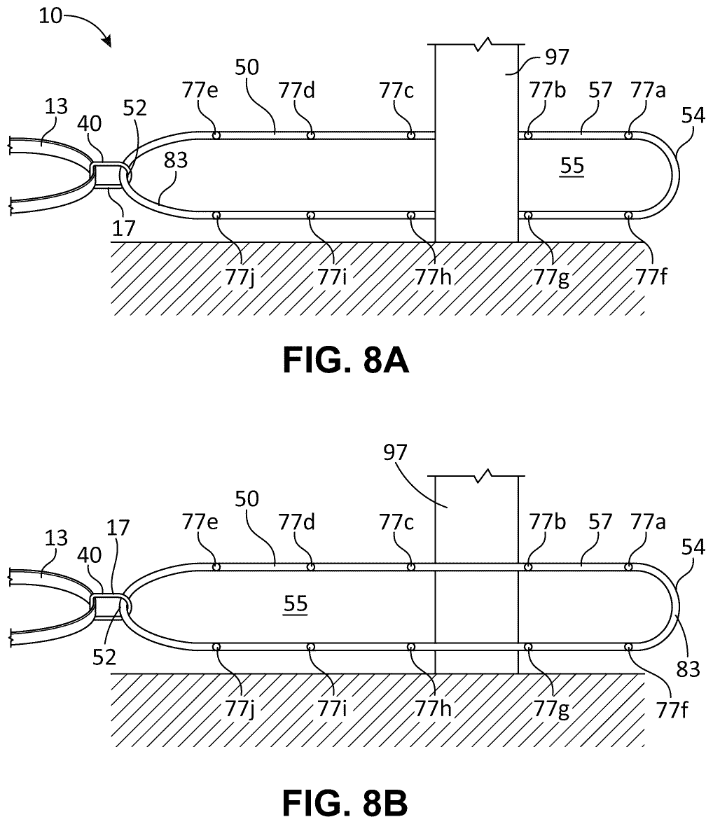

In operation of a pet leash apparatus, such as pet leash apparatus, 10, 100, should a lead, such as lead 50, 150, become entangled with an obstacle, such as obstacle 97 (see FIGS. 8A, 8B) including, for example, the pet itself, such as pet 99, 199, foliage, furniture, portions of a structure, the user may alter the lead from a fastened configuration, such as fastened configuration 59, 159, into into a looped configuration, such as looped configuration 57, 157. With the lead in the looped configuration, the user may then grip the lead at a lead portion, such as lead portion 83, at any convenient location and then reposition the lead portion with respect to a lead attachment, such as lead attachment 40, 140, by moving the lead portion in order to detangle the lead while maintaining a grip on the lead and control of a pet, such as pet 99, 199. The lead portion may be proximate distal end, such as distal end 52, 152, and the lead portion may be moved to proximal end, such as proximal end 54, 154. The user may need variously to grip the lead and shift the loop, such as loop 55, 155, several times while untangling slack portions of the lead from the obstacle.

Because the loop formed by the lead is moveably engaged with the lead attachment, gripping the loop anywhere and then tensioning the lead causes the loop to reposition with respect to the lead attachment until the gripped portion of the loop is positioned proximal to the lead attachment. Accordingly, the gripped portion of the loop moves to assume a constant length between the gripped portion and the lead attachment (e.g., the length between the lead attachment and the proximal portion of the lead) as the lead is tensioned. That is, the gripped portion is always positioned proximal to the lead attachment by tensioning of the loop to have a constant length between the gripped portion and the lead attachment. For example, with the lead in the looped configuration, the lead cooperates with the lead attachment to reposition a gripped portion of the lead proximate a distal end to the proximal end by tensioning of the lead at the gripped portion. For example, with the lead in the fastened configuration, the gripped portion of the lead is blocked from repositioning to the proximal end by fasteners attached to one another thereby blocking passage of the lead through the lead attachment. Fastened fasteners restrict movement of the lead through the lead attachment.

These operations of exemplary pet leash apparatus 10 are illustrated in FIGS. 8A, 8B. Exemplary pet leash apparatus 100 operates similarly to the operations of exemplary pet leash apparatus 10 illustrated in FIGS. 8A, 8B. As illustrated in FIG. 8A, lead 50 is disposed in part behind obstacle 97 that formed as a single vertical member for explanatory purposes. Fasteners 77a, 77b, 77c, 77d, 77e, 77f, 77g, 77h, 77i, 77j are detached from one another so that lead 50 is in looped configuration 57 forming loop 55. Lead portion 83 of lead 50, which is proximate distal end 52 is being gripped by the user and pulled (e.g., tensioned) generally in the direction indicated by an arrow in FIG. 8A. Note that lead portion 83 being gripped and then pulled may be other than proximal end 54 of lead 50 per this example.

As illustrated in FIG. 8B, by continued pulling upon lead portion 83, lead 50 is moved to the front of obstacle 97 and lead portion 83 shifts to become proximal end 54 of lead 50 at least in part by passage of lead 50 through lead attachment 40. Fasteners 77a, 77b, 77c, 77d, 77e, 77f, 77g, 77h, 77i, 77j and lead attachment 40 are configured so that fasteners 77a, 77b, 77c, 77d, 77e, 77f, 77g, 77h, 77i, 77j pass through lead attachment 40. Lead 50 may be tensioned in FIG. 8B in order to maintain control of pet 99 by maintaining a constant length of lead 50 (e.g., the length between distal end 52 and proximal end 54). Tensioning the lead in the looped configuration causes a gripped portion to slide through the lead attachment to a fixed proximal length. It should be noted that were lead 50 in fastened configuration 59 with, for example, fasteners 77e, 77j attached to one another, lead portion 83 of lead 50 being gripped may then shift toward proximal end 54 only until fasteners 77e, 77j contact lead attachment 40 thereby blocking further movement of lead 50 through lead attachment 40 thus preventing gripped portion from becoming proximal end 54.

In operations of the pet leash apparatus wherein the pet leash apparatus includes an elongate member, such pet leash apparatus 100, 200, 300 including elongate member 130, 230, 330, the elongate member is positioned between an extended position, such as extended position 137, 237 and a tensioned position, such as tensioned position 139, as the lead is slacked or tensioned, respectively. With the lead being slack (e.g., the pet is generally stationary at rest), the elongate member hingedly springingly tilts upward and/or outward away from the pet to position the lead in the extended position away from the pet thereby keeping the lead from being entangled with the pet such as with the legs or feet of the pet, such as pet 199, 299. The slack lead may be either in the looped configuration or in the fastened configuration, in some implementations. In other implementations, the lead may be formed as a strip of compliant material generally in fixed relation with the elongate member. With the lead tensioned (e.g., the pet pulling against the lead and/or the user pulling against the pet), the elongate member hingedly rotateably pivots with respect to the connector to be linearly aligned with the lead thereby transmitting only tension between the pet collar and the lead through the elongate member. The elongate member may compress the spring, such as spring 138, when so positioned so that release of tension causes the spring to position the elongate member in the extended position. Only force of the spring acts on the elongate member in the extended position. The lead applies tension force to the elongate member to overcome at least in part the force of the spring in the tensioned position. Because the elongate member is positionable, the elongate member may thus carry only tension force of the tensioned lead other than the force of the spring in the tensioned position. The elongate member may swivelably cooperate with the connector by a swivel, such as swivel 123, 323, to allow positioning of elongate member 330 in a horizontal plane (e.g., side to side). The swivel for example allows positioning the elongate member outward the side of the pet (e.g., perpendicular to the spine of the pet). The swivel may be spring loaded to preferentially align elongate member parallel with the spine of the pet.

In some implementations, the loop may be rotated freely through 360° with respect to the lead attachment, while, in other aspects, the lead may include a structure disposed thereupon that prevents the loop from rotating freely through 360° while allowing for rotation of the loop most of but not entirely through 360°, say through about 270°. In certain implementations, the lead may transition between moveable engagement with the lead attachment that allows rotation of the loop with respect to the lead attachment and fixed engagement with the lead attachment that generally prevents rotation of the loop with respect to the lead attachment.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. §1.72(b) only. Accordingly, the Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A pet leash apparatus, comprising:
a lead comprised of a flexible material to resist only tension forces;
a lead attachment in mechanical cooperation with the lead;
an elongate member, the elongate member having a first end that cooperates with a pet collar and a second end that cooperates with the lead attachment, the elongate member being positionable between an extended position by slacking of the lead and a tensioned position by tensioning of the lead.

2. The apparatus of claim 1, wherein the lead defines a loop.

3. The apparatus of claim 2, wherein the lead attachment comprises a ring that slideably receives the lead.

4. The apparatus of claim 2, further comprising;
a pulley with a wheel of the pulley configured to pass the lead through the pulley by rotation of the wheel, the lead attachment comprising the pulley.

5. The apparatus of claim 4, wherein the wheel of the pulley includes a groove configured to cooperate with fasteners disposed along the lead to allow the lead including the fasteners to pass through the pulley.

6. The apparatus of claim 2, further comprising:
a plurality of fasteners disposed along the lead that cooperate with one another to attach and detach portions of the lead with each other thereby altering the lead between a fastened configuration having one or more of the plurality of fasteners attached to one another and a looped configuration having all of the fasteners detached from one another thereby defining the loop;
wherein the lead is configurable between: (i) a looped configuration in which the fasteners are detached and the lead forms a continuous loop; and (ii) a fastened configuration in which at least some fasteners are attached, restricting movement through the lead attachment
and wherein, with the lead in the looped configuration, the lead attachment cooperates with the lead to reposition a gripped portion of the lead proximate a distal end to the proximal end by tensioning of the lead at the gripped portion, and, with the lead in the fastened configuration, the gripped portion of the lead is blocked from repositioning to the proximal end.

7. The apparatus of claim 6 wherein the fasteners comprise hook and loop fasteners configured to engage one another.

8. The apparatus of claim 1, wherein the elongate member is configured to alter between the extended position and the tensioned position generally in a plane.

9. The apparatus of claim 1, further comprising:
a swivel disposed between the pet collar and the elongate member to position rotatably the extended position and the tensioned position about the pet collar.

10. The apparatus of claim 1, further comprising:
a connector in hinged cooperation with the first end of the elongate member, the elongate member hingedly rotates about the connector between the extended position and the tensioned position.

11. The apparatus of claim 1, further comprising:
a spring in cooperation with the elongate member to position springingly the elongate member from the extended position to the tensioned position by slacking of the lead.

12. The apparatus of claim 11, further comprising:
a swivel in cooperation with the connector to rotate the connector and elongate member about the pet collar.

13. A pet leash apparatus, comprising:
a lead formed of a flexible material to resist only tension forces and defining one continuous loop;
a lead attachment in mechanical cooperation with the lead;
an elongate member, the elongate member having a first end that cooperates with a pet collar and a second end that cooperates with the lead attachment, the elongate member being positionable between an extended position by slacking of the lead and a tensioned position by tensioning of the lead;
and wherein, with the lead defining the loop, the lead attachment cooperates with the lead to reposition a gripped portion of the lead proximate a distal end to the proximal end by tensioning of the lead at the gripped portion.

14. The apparatus of claim 13, further comprising:
a plurality of fasteners disposed along the lead to alter the lead between a fastened configuration having a series of gaps disposed along the lead with one or more of the plurality of fasteners attached to one another and a looped configuration having the one continuous loop with all of the fasteners detached from one another.

15. The apparatus of claim 14, wherein with the lead in the fastened configuration, the gripped portion of the lead is blocked by fastened fasteners from repositioning to the proximal end.

16. The apparatus of claim 14 wherein the fasteners are selected from hook-and-loop fasteners, magnets, magnetic materials, or mechanical snap fasteners

17. The apparatus of claim 13, further comprising:
a connector in cooperation with the first end of the elongate member and with the pet collar to allow hinged swivelable movement of the elongate member with respect to the pet collar.

18. The apparatus of claim 17, further comprising:
a spring in cooperation with the elongate member to position springingly the elongate member from the tensioned position to the extended position by slacking of the lead.

19. The apparatus of claim 13, wherein the lead attachment comprises a ring that slideably receives the lead.

20. The apparatus of claim 13, wherein the lead attachment comprises a pulley with a wheel of the pulley configured to pass the lead through the pulley by rotation of the wheel.
